(19) United States
(12) Patent Application Publication
(10) Pub. No.: US 2013/0010416 A1
(43) Pub. Date: Jan. 10, 2013

(54) ELECTRONIC DEVICE HAVING FUNCTION OF FIXING A KEYBOARD MECHANISM

(76) Inventor: Te-Wei Chang, New Taipei City (TW)

(21) Appl. No.: 13/279,340

(22) Filed: Oct. 24, 2011

(30) Foreign Application Priority Data
Jul. 6, 2011 (TW) 100123824

(51) Int. Cl. G06F 1/16

(52) U.S. Cl. 361/679.08

(57) ABSTRACT

An electronic device having function of fixing a keyboard mechanism is disclosed in the present invention. The electronic device includes a casing for holding the keyboard mechanism, and an accommodating space is formed on a lateral inner wall of the casing. The electronic device further includes a hook mechanism disposed inside the accommodating space on the casing. The hook mechanism includes an arm base, and an end of the arm base is connected to a surface of the accommodating space. The hook mechanism further includes a hook portion disposed on the arm base for contacting against the keyboard mechanism, so as to constrain a movement of the keyboard mechanism relative to the casing.

### BACKGROUND OF THE INVENTION

1. Field of the Invention

The present invention relates to an electronic device having function of fixing a keyboard mechanism, and more particularly, to an electronic device having a hook mechanism with advantages of low cost and preferable yield to fix the keyboard mechanism on a casing.

2. Description of the Prior Art

A hook structure is utilized to contact against a surface of a keyboard mechanism for constraining a movement of the keyboard mechanism relative to a casing, so as to stably fix the keyboard mechanism inside the casing of an electronic device, such as a host casing of the notebook computer. The conventional hook structure is a detachable hook structure. The conventional detachable hook structure includes a main body, two fixing portions respectively disposed on two ends of the main body, and a contacting portion disposed on a middle of the main body. The conventional detachable hook structure is fixed on a predetermined position inside the host casing by melt glue or a screw for assembly, so that the contacting portion of the conventional detachable hook structure can contact against the surface of the keyboard mechanism. However, assembly of the conventional detachable hook structure spends working hours, and an idle-proof function of the conventional detachable hook structure is necessary to prevent the assembly from being failed, which increases manufacturing cost. Therefore, design of a hook structure for economizing working hours and increasing manufacturing efficiency is an important issue of the computer industry.

### SUMMARY OF THE INVENTION

The present invention provides an electronic device having a hook mechanism with advantages of low cost and preferable yield to fix the keyboard mechanism on a casing for solving above drawbacks.

According to the claimed invention, an electronic device includes a casing for holding a keyboard mechanism, and an accommodating space is formed on a lateral inner wall of the casing. The electronic device further includes a hook mechanism disposed inside the accommodating space on the casing. The hook mechanism includes an arm base, and an end of the arm base is connected to a surface of the accommodating space. The hook mechanism further includes a hook portion disposed on the arm base for contacting against the keyboard mechanism, so as to constrain a movement of the key board mechanism relative to the casing.

According to the claimed invention, the casing comprises a bottom for supporting the keyboard mechanism, and the bottom intersects the lateral inner wall.

According to the claimed invention, the end of the arm base is connected to the surface of the accommodating space in a resiliently flexible manner.

According to the claimed invention, a lateral surface of the arm base is substantially parallel to the lateral inner wall of the casing, a low surface of the hook portion is for contacting against the keyboard mechanism, and the low surface of the hook portion intersects the lateral surface of the arm base.

According to the claimed invention, the low surface of the hook portion is substantially perpendicular to the lateral surface of the arm base.

According to the claimed invention, the arm base is contained inside the accommodating space, and the hook portion protrudes from the accommodating space.

According to the claimed invention, the hook mechanism further comprises a rib disposed between the hook portion and the arm base.

According to the claimed invention, the rib is disposed on an upper surface of the hook portion, and the rib is an inclined structure.

According to the claimed invention, a plurality of accommodating space is formed on the lateral inner wall of the casing, the electronic device further comprises a plurality of hook mechanisms, and each hook mechanism is disposed inside the corresponding accommodating space on the casing.

According to the claimed invention, the hook mechanism further comprises a protrusion disposed on a bottom of the arm base.

According to the claimed invention, the other end of the arm base is connected to the other surface of the accommodating space.

According to the claimed invention, the hook mechanism is integrated with the casing monolithically and is contained inside the accommodating space.

The hook mechanism is integrated with the casing of the electronic device monolithically in the present invention, so as to effectively decrease manufacturing cost and increase product yield. In addition, the hook mechanism of the present invention can be the cantilever structure with preferable flexible intensity, so that the keyboard mechanism can be installed on the casing without tools, and has advantages of simple assembly and rapid operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic device according to an embodiment of the present invention.

FIG. 2 is an enlarged diagram of a hook mechanism according to the embodiment of the present invention.

FIG. 3 to FIG. 5 are sectional views of the electronic device in different operating modes according to the embodiment of the present invention.

### DETAILED DESCRIPTION

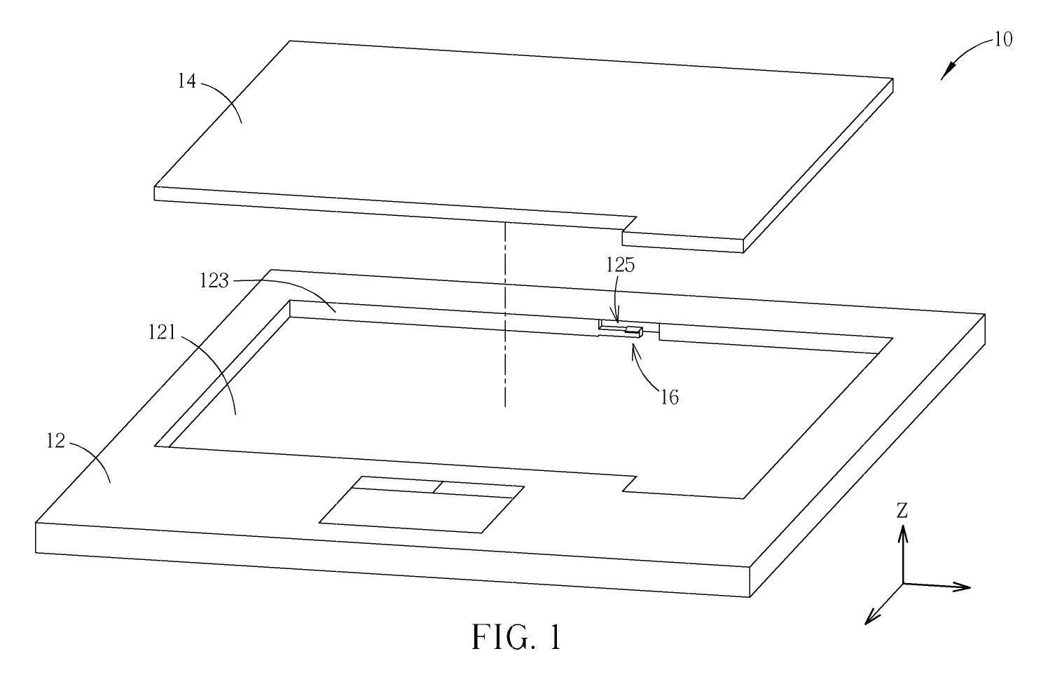

Please refer to FIG. 1. FIG. 1 is a diagram of an electronic device 10 according to an embodiment of the present invention. The electronic device 10 includes a casing 12 for holding a keyboard mechanism 14. For example, the electronic device 10 can be a notebook computer, the notebook computer includes a panel casing and a host casing (which is the casing 12), and the keyboard mechanism 14 is installed on the host casing. The casing 12 includes a bottom 121 and a lateral inner wall 123, and the bottom 121 intersects the lateral inner wall 123. The lateral inner wall 123 can be substantially perpendicular to the bottom 121 for setting the keyboard mechanism 14 on the bottom 121 conveniently, so that the keyboard mechanism 14 can move into the casing 12 along a Z-axis and be located on the bottom 121.

In addition, an accommodating space 125 is formed on the lateral inner wall 123 of the casing 12. The electronic device 10 further includes a hook mechanism 16 disposed inside the accommodating space 125. The hook mechanism 16 includes an arm base 18, and a hook portion 20 disposed on the arm base 18. An end of the arm base 18 can be connected to a surface of the accommodating space 125 monolithically in a resiliently flexible manner. In the embodiment, the hook mechanism 16 can be a single cantilever hook mechanism 16, and the hook portion 20 can be for contacting against the keyboard mechanism 14, so as to constrain a movement of the keyboard mechanism 14 relative to the casing 12 along the Z-axis.

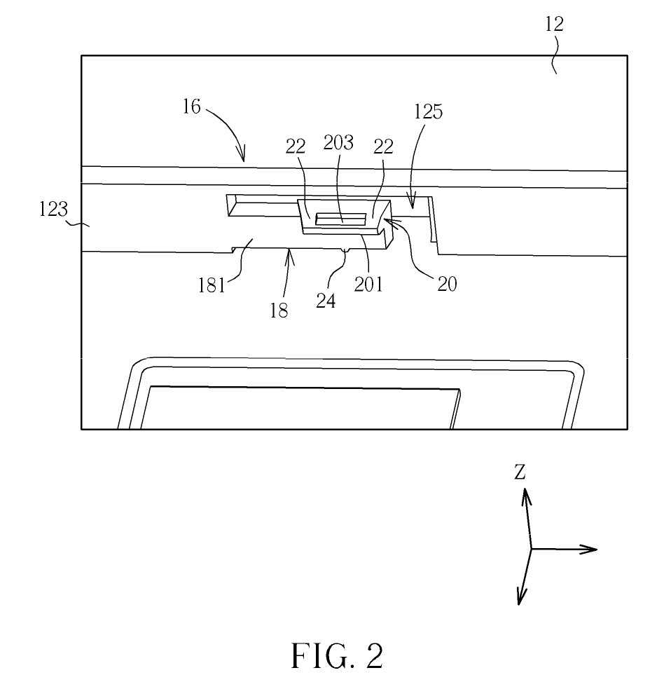

Please refer to FIG. 1 and FIG. 2. FIG. 2 is an enlarged diagram of the hook mechanism 16 according to the embodiment of the present invention. A lateral surface 181 of the arm base 18 can be substantially parallel to the lateral inner wall 123 of the casing 12. A low surface 201 of the hook portion 20 can be for contacting against the keyboard mechanism 14, and the low surface 201 of the hook portion 20 can intersect the lateral surface 181 of the arm base 18. As shown in FIG. 2, the arm base 18 can be contained inside the accommodating space 125, and the hook portion 20 can protrude from the accommodating space 125, so that the hook portion 20 can contact against the keyboard mechanism 14 for preventing the keyboard mechanism 14 from separating from the casing 12 along the Z-axis. Generally, the low surface 201 of the hook portion 20 can substantially perpendicular to the lateral surface 181 of the arm base 18, so as to tightly contact the surface of the keyboard mechanism 14 for stable assembly.

Furthermore, the hook mechanism 16 can further include two ribs 22 disposed between the hook portion 20 and the arm base 18. Because the hook mechanism 16 is for preventing the keyboard mechanism 14 from separating from the casing 12, the rib 22 can strengthen intensity of the hook portion 20 for preventing the hook portion 20 from being broken or bent relative to the arm base 18. It should be mentioned that the rib 22 can be an inclined structure, as shown in FIG. 2, and the inclined structure can be formed on an upper surface 203 of the hook portion 20. When the keyboard 14 is moved into the casing 12 along the Z-axis, the keyboard mechanism 14 can be for directly pressing the inclined structure of the rib 22, so as to bend the arm base 18 relative to the casing 12. Meanwhile, the hook portion 20 is pressed into the accommodating space 125 for preventing the keyboard mechanism 14 and the casing from structural interference due to of the hook portion 20. The hook mechanism 16 can further include a protrusion 24 disposed on the bottom of the arm base 18. When the hook mechanism 14 is resiliently deformed by press from the keyboard mechanism 14, the protrusion 24 can contact against the bottom 121 of the casing 12, so as to prevent the arm base 18 from excessively bending.

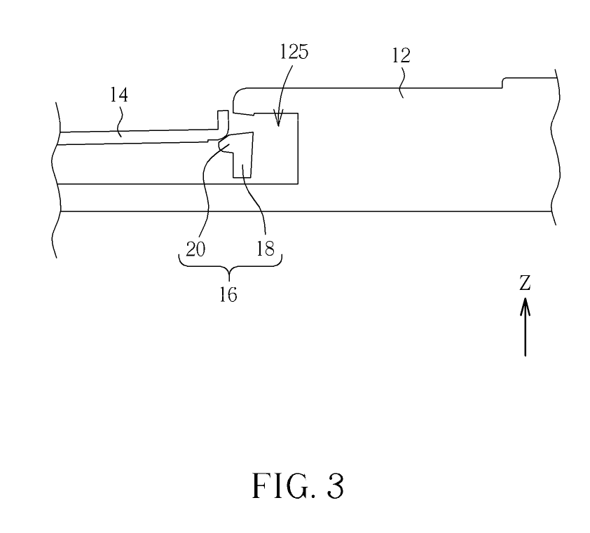

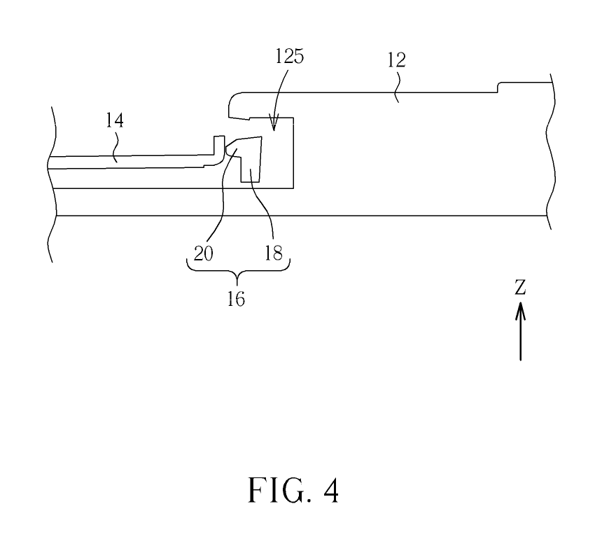

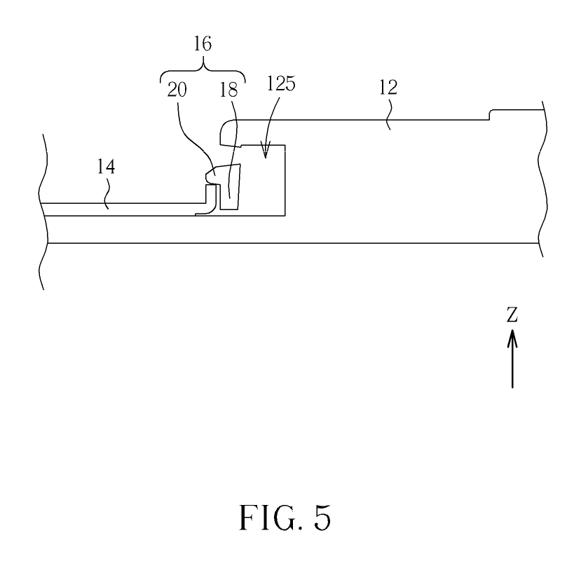

Please refer to FIG. 3 to FIG. 5. FIG. 3 to FIG. 5 are sectional views of the electronic device 10 in different operating modes according to the embodiment of the present invention. As shown in FIG. 3, the keyboard mechanism 14 is not installed inside the casing 12, and the hook portion 20 of the hook mechanism 16 protrudes from the accommodating space 125 on the casing 12. As shown in FIG. 4, because the rib 22 can be the inclined structure, the arm base 18 can be bent relative to the casing 12 by sliding the keyboard mechanism 14 relative to the rib 22, so as to move the hook portion 20 into the accommodating space 125 when the keyboard mechanism 14 is installed inside the casing 12 along the Z-axis, and the keyboard mechanism 14 contacts against the rib 22 of the hook mechanism 16. Thus, the structural interference of the hook mechanism 16 can be rapidly released for installing the keyboard mechanism 14 inside the casing 12 by the inclined structure of the rib 22. Final, as shown in FIG. 5, because the rib 22 is not pressed by the keyboard mechanism 14, the arm base 18 can recover to an initial position when the keyboard mechanism 14 has been installed on the bottom 121 of the casing 12, which means that the arm base 18 can be substantially parallel to the lateral inner wall 123 of the casing 12, and the hook portion 20 can protrude from the accommodating space 125. Therefore, the low surface 201 of the hook portion 20 can contact against the keyboard mechanism 14 for preventing the movement of the keyboard mechanism 14 relative to the casing 12, so as to accomplish the assembly of the keyboard mechanism 14.

In conclusion, the hook mechanism of the present invention can be integrated with the casing monolithically. Due to the flexible cantilever structure of the hook mechanism, the hook mechanism can be bent relative to the casing by press from the keyboard mechanism, so the keyboard mechanism can be installed inside the casing easily and rapidly without tools. For increasing structural stability of the keyboard mechanism, the plurality of accommodating space can be formed on the casing in the present invention, and the electronic device of the present invention can include the plurality of hook mechanisms. The plurality of accommodating space can be respectively formed on each lateral wall of the casing, and each hook mechanism can be disposed inside the corresponding accommodating space on the casing, so that the plurality of hook mechanisms can respectively contact around the keyboard mechanism for preferable structural stability. Besides, the other end of the arm base can be integrated with the other surface of the accommodating space monolithically, which means that the hook mechanism can be a dual-cantilever structure for increasing structural strength of the arm base of the hook mechanism, so as to prevent constraint of the keyboard mechanism and the casing from being released due to deformation of the hook mechanism by an accident. Amounts and shapes of the hook mechanism of the electronic device of the present invention are not limited to the above-mentioned embodiment, and depend on design demand.

Comparing to the prior art, the hook mechanism is integrated with the casing of the electronic device monolithically in the present invention, so as to effectively decrease manufacturing cost and increase product yield. In addition, the hook mechanism of the present invention can be the cantilever structure with preferable flexible intensity, so that the keyboard mechanism can be installed on the casing without tools, and has advantages of simple assembly and rapid operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device comprising:
a casing for holding a keyboard mechanism, an accommodating space being formed on a lateral inner wall of the casing; and
a hook mechanism disposed inside the accommodating space on the casing, the hook mechanism comprising:
an arm base, an end of the arm base being connected to a surface of the accommodating space; and
a hook portion disposed on the arm base for contacting against the keyboard mechanism, so as to constrain a movement of the key board mechanism relative to the casing.

2. The electronic device of claim 1, wherein the casing comprises a bottom for supporting the keyboard mechanism, and the bottom intersects the lateral inner wall.

3. The electronic device of claim 1, wherein the end of the arm base is connected to the surface of the accommodating space in a resiliently flexible manner.

4. The electronic device of claim 1, wherein a lateral surface of the arm base is substantially parallel to the lateral inner wall of the casing, a low surface of the hook portion is for contacting against the keyboard mechanism, and the low surface of the hook portion intersects the lateral surface of the arm base.

5. The electronic device of claim 4, wherein the low surface of the hook portion is substantially perpendicular to the lateral surface of the arm base.

6. The electronic device of claim 1, wherein the arm base is contained inside the accommodating space, and the hook portion protrudes from the accommodating space.

7. The electronic device of claim 1, wherein the hook mechanism further comprises a rib disposed between the hook portion and the arm base.

8. The electronic device of claim 7, wherein the rib is disposed on an upper surface of the hook portion, and the rib is an inclined structure.

9. The electronic device of claim 1, wherein a plurality of accommodating space is formed on the lateral inner wall of the casing, the electronic device further comprises a plurality of hook mechanisms, and each hook mechanism is disposed inside the corresponding accommodating space on the casing.

10. The electronic device of claim 1, wherein the hook mechanism further comprises a protrusion disposed on a bottom of the arm base.

11. The electronic device of claim 1, wherein the other end of the arm base is connected to the other surface of the accommodating space.

12. The electronic device of claim 1, wherein the hook mechanism is integrated with the casing monolithically and is contained inside the accommodating space.
